(19) United States
(12) Patent Application Publication
(10) Pub. No.: US 2003/0078156 A1
(43) Pub. Date: Apr. 24, 2003

(54) Creep resistant refractory with controlled optical emission

(76) Inventors: Richard A. Lowden, Clinton, TN (US); Robert J. Lauf, Oak Ridge, TN (US); Frederick C. Montgomery, Oak Ridge, TN (US); Claudia J. Rawn, Knoxville, TN (US)

Correspondence Address: UT-Battelle, LLC, 111 Union Valley Rd., PO Box 2008, Mail Stop 6498, Oak Ridge, TN, 37831, US

(21) Appl. No.: 09/935,852

(22) Filed: Aug. 23, 2001

(51) Int. Cl. C04B 35/50; C04B 35/10

(52) U.S. Cl. 501/127; 501/152; 501/153; 264/642

(57) ABSTRACT

A creep-resistant and chemical-resistant ceramic refractory composition includes a mixed oxide of the general formula R₃Al₅O₁₂ where R is at least one of Dy, Ho, Y, Er, Tm, Yb, and Lu, the mixed oxide having a garnet structure and comprising in solid solution at least one dopant of a transition metal element and a rare-earth element, which effects in the composition enhanced optical emission in at least one spectral range.

The United States Government has rights in this invention pursuant to contract no. DE-AC05-00OR22725 between the United States Department of Energy and UT-Battelle, LLC.

The present invention relates to refractory materials and components capable of resisting creep deformation and chemical attack while radiating enhanced infrared energy over selected spectral regions.

Ceramic refractories are widely found in high-temperature, chemically demanding applications and are critical construction materials for energy-intensive industries. Refractories are made in many forms: the roof of a glass melting furnace is usually a self-supporting arch of dense alumina refractory bricks; ladles for molten steel or aluminum may be lined with bricks or with a mixture that is rammed into place somewhat like concrete; high-temperature combustors can be lined with a lower density fibrous ceramic board or blanket, which may also serve as the host or support for a catalyst, often applied as a wash coat after the refractory is in place.

Refractory materials have remained largely unchanged for many years and fundamentally new refractory systems are needed because alumina-based materials are reaching their ultimate performance limits with respect to chemical and mechanical wear and tear. Areas where breakthroughs are needed are in strengthening the base refractory material for creep resistance, improving chemical resistance thereof, and, at the same time, giving it the added functionality of acting as a host for advanced catalysts. For many boilers and furnaces, the time between rebuilds is directly related to the ability of the refractory to resist creep or sagging, corrosion, erosion, and other slow degradation processes.

The present invention described herein arose as an unexpected confluence of several unrelated pieces of work concerning rare-earth doped alumina and similar materials. There is logical interest in oxide refractories for high-temperature applications in oxidizing environments where extremely creep-resistant materials such as carbides and nitrides are chemically unstable. Unfortunately, high-alumina ceramics exhibit high diffusion rates that affect chemical stability, grain growth, and creep. At the same time, there is great interest in oxides or other refractories that have catalytic properties for catalytic combustors and other systems. Based on the analysis that follows, yttrium aluminum garnet, commonly known as “YAG”, (Y₃Al₅O₁₂) holds promise to be a good refractory from creep and chemical resistance alone, and maybe an even more useful refractory if the emissivity can be tailored through doping.

Creep Resistance of YAG

Please see the following: T. A. Parthasarathy, T. -I. Mah, and K. Keller, “Creep Mechanism of Polycrystalline Yttrium Aluminum Garnet,” J. Am. Cer. Soc. 75, 1756-1759 (1992); and T. A. Parthasarathy, T. -I. Mah, and L. Matson, “Deformation Behavior of an Al₂O₃—Y₃Al₅O₁₂ Eutectic Composite in Comparison with Sapphire and YAG,” J. Am. Cer. Soc. 76, 29-32 (1993). Those researchers reported high temperature deformation studies on bulk polycrystalline YAG compositions. Their testing method (displacement-controlled testing), which often introduces errors in the calculation and interpretation of strain, was used to generate stress-strain information. They found their YAG compositions and derivatives to be more creep resistant than alumina at all explored temperatures (1410, 1530, and 1650° C.).

Others have tested single-crystal YAG or polycrystalline YAG fibers and also found them to be creep resistant. Please see: W. R. Blumenthal and D. S. Phillips, “High-Temperature Deformation of Single-Crystal Yttrium-Aluminum Garnet (YAG),” J. Am. Cer. Soc. 79, 1047-1052 (1996); S. S. Sternstein and R. Warren, “Dynamic and Transient Characterization of Ceramic Fibers at Elevated Temperatures,” Cer. Eng. Sci. Proc. 18, 331-338 (1997); and G. N. Morscher, K. C. Chen, and K. S. Mazdiyasni, “Creep-Resistance of Developmental Polycrystalline Yttrium-Aluminum Garnet Fibers,” Cer. Eng. Sci. Proc. 18, 181-187 (1997)]. As will be discussed in greater detail, Applicants synthesized a large number of different materials and characterized their creep resistance using contact extensometry, which measures actual compressive strain of a specimen and thus eliminates errors in the calculation and interpretation of strain. It can be confidently stated that the compression test facilities and creep strain measurement capabilities used by Applicants are superior to those described by others who have tested YAG and furthermore the data reported herein supports Applicants' claim that a general pattern of creep resistance exists for mixed-oxide materials having the garnet structure defined by the general formula R₃Al₅O₁₂ where R is at least one of Dy, Ho, Y, Er, Tm, Yb, and Lu. Also previously unrecognized is that all of these compounds are super-emissive and can serve as a host structure to a variety of dopants, thereby greatly expanding the available spectrum of radiant emitters while preserving key attributes of creep and chemical resistance and a common synthesis or processing route.

There apparently has not been any creep testing of other rare-earth garnets to determine if good creep resistance is in any way a general thing or is unique to YAG. The YAG materials tested by Parthasarathy et al. were arguably lacking creep resistance at 1530° C. and above, so it is estimated that the threshold temperature for more severe-loading structural applications is likely to be <1500° C. However, for refractory applications, the applied loads are relatively small (compared to those of engine components, for example) and are often only due to the mass and thermal expansion of the superstructure itself. So service above 1500° C. could be quite possible in such low-stress applications because the creep rates would be correspondingly small.

Chemical Resistance of YAG

YAG is an extremely stable oxide, as demonstrated by the following: R. J. Lauf and J. H. DeVan, “Evaluation of Ceramic Insulators for Lithium Electrochemical Reduction Cells,” J. Electrochem. Soc. 139 [8], 2087-91 (1992). It was found to be one of very few insulating refractories to withstand contact with molten lithium. What was not appreciated therein is that resistance to chemical attack, especially to partial reduction, is a key attribute of the present invention, because Applicants intend to use the aluminum garnet phase as a host for optically active dopants in order to achieve the desired super-emissive behavior. It will be appreciated that if the host compound becomes partially reduced, the operative emission processes might shift or become quenched altogether. The most obvious effect of partial reduction is the creation of broad absorption bands in normally transparent oxides and this will interfere with optimal emission of fluorescent lines from the dopants or from the matrix itself in the case of compounds such as Er₃Al₅O₁₂.

Feasibility of YAG as an Emitter

Recent work by others has indicated that powders of rare-earth aluminum garnets were difficult to sinter. This is consistent with the expectation that YAG would be creep resistant, because similar microscopic processes govern creep and sintering kinetics. Interest in the rare-earth-doped garnets is not limited to structural applications but includes burners with controlled spectral emission for enhancing interaction with selected substrates for applications such as thermophotovoltaic (TPV) systems or paper drying. A TPV system burns gas in an incandescent mantle (like a camping lantern), and photovoltaic panels convert the light to electricity, thereby converting fuel to electricity with no moving parts. It should be noted that most TPV systems rely on a very low-density emitter, so creep strength is not a crucial attribute.

Prior work has tended to focus on thermal shock resistance and general fragility of the emissive materials rather than their creep strength per se. Others have been examining many different rare-earth doped materials to control the spectral emission from a burner specifically to better match the spectral response of silicon PV cells, to minimize IR heating and maximize conversion efficiency. Others have also attempted to improve the efficiency of gas-fired radiant burners for drying paper by altering spectral emission to better interact with water molecules. Various workers have shown that fluorescence lines of some rare-earth oxides may show up as distinctive features superimposed on the general blackbody emission. (All of these materials are broadly referred to as “super-emissive” in reference to their ability to emit larger amounts of light at certain wavelengths than would be expected based only on blackbody or gray-body emission.) If these wavelengths are selected to correspond to strong absorption bands in the gas phase, possibly large enhancements of reaction rates could occur. The significance of the effect and the effects of modifications, both in terms of dopants and in terms of structural substitutions, can only be determined experimentally.

A further body of work concerns thermophosphors used for non-contact temperature measurement. When these materials are excited by a pulsed laser (typically UV), the resulting optical emission at a longer wavelength decays with a time constant that is temperature dependent. Other workers have shown that doped YAG thermophosphors in some cases can be used as high as 1400° C., suggesting that the operative electron energy states for fluorescence are not saturated at that temperature. See W. Lewis, W. D. Turley, H. M. Borella, and B. W. Noel, “Noncontact Thermometry in Excess of 2500 F using Thermographic Phosphors,” in Proceedings of the 36th International Instrumentation Symposium: Instrumentation for the Aerospace Industry (Instrument Society of America, Research Triangle Park, North Carolina, 1990), pp. 23-27.

Based upon the foregoing, Applicants concluded that it was reasonable to formulate and test a number of different compounds to determine if they possess a unique combination of properties including: creep resistance; chemical or corrosion resistance; and optical emission over selected spectral regions. A further goal of this development program was to determine if these properties could be attributed to generalized groups of related compounds, or are unique to YAG.

A study of past developments revealed the following U.S. patents:

U.S. Pat. No. 6,159,001 issued to Kushch, et al. on Dec. 12, 2000 is typical of the general art of emissive bodies deployed in a burner to convert thermal energy to IR emissions. This patent describes “super-emissive materials” (typically rare-earth oxides) as coatings on a supporting structural refractory material (typically alumina but '001 also mentions glass, ceramic fibers, refractory metals, etc.)

U.S. Pat. No. 6,126,888 issued to Goldstein on Oct. 3, 2000 is a specific modification of the “relic method” in which a cloth structure is infiltrated with a metal precursor compound, which is then carefully burned to create a fibrous relic structure of the desired metal oxide. In '888 the item of claimed novelty is that the cloth is first carbonized before infiltration with the rare-earth precursor materials.

U.S. Pat. No. 6,091,018 issued to Fraas, et al. on Jul. 18, 2000 describes thermophotovoltaic systems employing a three-layer solid IR emitter. A structural support is provided by fiber-reinforced alumina. An intermediate black absorptive layer is provided to prevent shine-through for more spectral selectivity. The emissive layer is Ni- or Co-doped alumina, erbium oxide, or both.

U.S. Pat. No. 5,942,047 issued to Fraas, et al on Aug. 24, 1999 provides an excellent general description of TPV systems. It claims a multilayer emitter and discusses a “reinforcing layer” of SiC, silicon nitride, BN, and refractory metals. “Garnet” is mentioned as one choice for the emissive layer, but '047 does not specify what type of “garnet” is contemplated. In the absence of any defining information in the specification, one has to rely on the “textbook” definition of garnet as a family of naturally occurring cubic silicate minerals. None of these minerals is stable at elevated temperatures and atmospheric pressure, and therefore would not be suitable as a refractory. None of them could be prepared by sintering, since they are inherently high-pressure phases. The preferred emitter in '047 is MgO:Co and aluinina:Co and it is noted that these have poor thermal shock performance. According to '047, “A variety of emitters are possible with the two important elements being continuous fiber reinforcement for durability and doping for spectral control.” Clearly, an inherently creep-resistant emitter is not contemplated nor taught by '047

U.S. Pat. No. 5,865,906 issued to Ferguson, et al. on Feb. 2, 1999 describes another emitter based on Co-doped alumina or magnesia.

U.S. Pat. No. 5,837,011 issued to Wong on Nov. 17, 1998 is typical of many patents on making metal oxide fiber or cloth by the “relic method”, which has been known since the days of the Welsbach Mantle (pre-1900) [Carl Auer von Welsbach, Brit. Pat. No. 124]. The claimed materials in '011 are rare-earth oxides.

U.S. Pat. No. 5,782,629 issued to Lannutti on Jul. 21, 1998 describes a low-cost way to make a zirconia (ZrO₂) emitter using the in situ decomposition of zircon (ZrSiO₄). Zirconia is desired because of its superior mechanical properties compared to aluminosilicates.

U.S. Pat. No. 5,686,368 issued to Wong on Nov. 11, 1997 describes another “relic” method for making fibrous emitters. Several rare-earth oxides are claimed, along with the use of ThO₂ to control grain growth during sintering. '368 discusses the importance of fiber strength and flexibility but does not mention creep.

U.S. Pat. No. 5,601,661 issued to Milstein, et al. on Feb. 11, 1997 describes certain specific types of narrow-band emitters (method of use patent). Described materials include Yb—Al garnet as well as Al₂O₃ and YbAlO₃. Creep resistance is not cited as a performance attribute—the main objective in '661 is thermal shock resistance and all claims relate to fairly specific physical structures with well-defined pore distributions. The independent claim also includes “epoxies and plastics” in the list of candidate materials, which is clearly inconsistent with the intended use.

U.S. Pat. No. 5,500,054 issued to Goldstein on Mar. 19, 1996 describes a light pipe approach as a means of isolating the PV element from the thermal energy. Among the many claimed emissive materials are “aluminum-ytterbium-yttrium mixed oxides” but no mention is made of which phase or phases are desired and no mention is made of creep resistance, since the emitter material is not used in a structural role.

U.S. Pat. No. 4,776,895 issued to Goldstein on Oct. 11, 1988 describes an improved TPV system in which the emission wavelengths of the emitter are matched to the absorption band of the PV element.

The above study is not intended to be exhaustive. None of the cited references appear to suggest the inherent creep resistance of the specifically claimed family of compounds, nor the specific utility of a creep-resistant and chemical-resistant super-emitter, nor the fabrication of monolithic, strong super-emitters by liquid-phase sintering.

Therefore objects of the present invention include the provision of: a creep-resistant refractory material having super-emissive properties; a creep-resistant refractory material that is resistant to oxidation and chemical attack; a creep-resistant refractory material that is resistant to partial reduction in low-oxygen environments; and a family of similarly creep-resistant refractory materials having super-emissive properties over various selected spectral ranges, whereby their super-emission may be matched to the absorption bands of a material or process to be heated.

Other objects of the present invention include the provision of methods of making: a creep-resistant refractory material having super-emissive properties; a creep-resistant refractory material that is resistant to oxidation and chemical attack; a creep-resistant refractory material that is resistant to partial reduction in low-oxygen environments; and a family of similarly creep-resistant refractory materials having super-emissive properties over various selected spectral ranges, whereby their super-emission may be matched to the absorption bands of a material or process to be heated.

Further objects of the present invention include the provision of methods of making a creep-resistant refractory material having super-emissive properties as a coating upon a lower-cost refractory material.

Other objects and advantages will be accomplished by the present invention, which is designed to create a highly stable, creep-resistant rare-earth aluminum garnet refractory characterized by super-emissivity over a desired spectral range. The spectral range may be defined by selectively doping with one or more rare-earth elements or transition metals and may be selected to enhance the radiative transfer of thermal energy to a selected chemical or industrial process. Some applicable purposes include combustion, pyrolysis, drying, selective chemical synthesis or decomposition, and others.

Further and other objects and advantages of the present invention will become apparent from the description contained herein, read together with the attached Drawings, which are briefly described as follows.

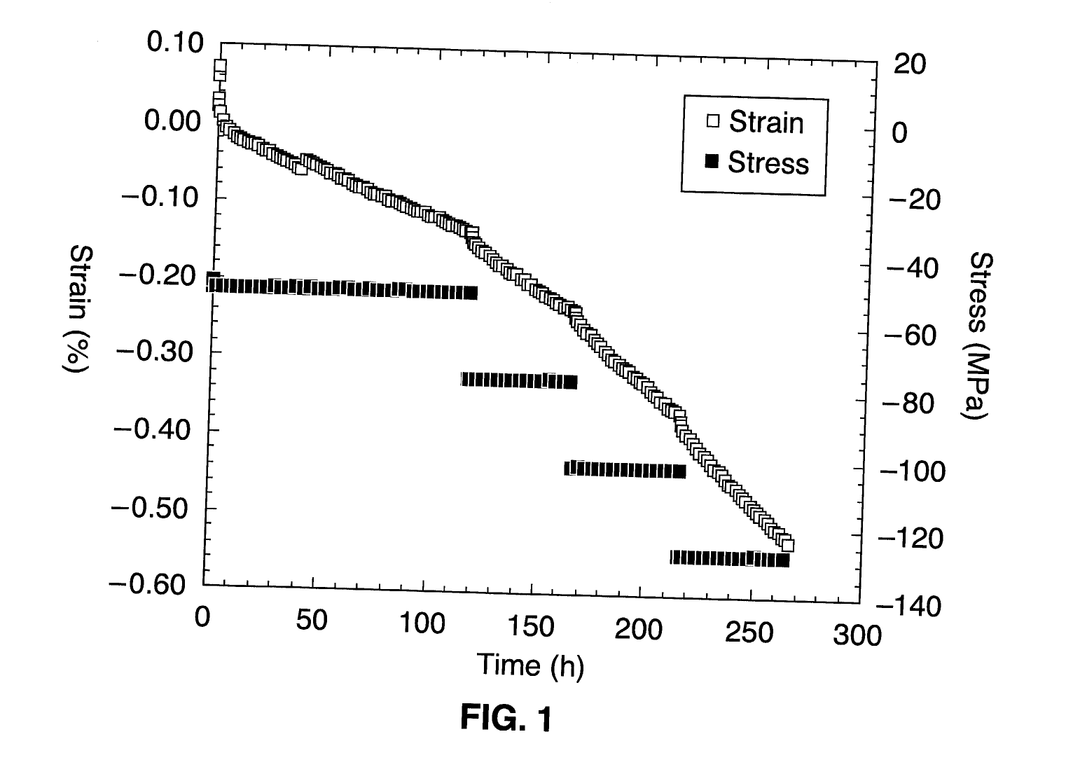

FIG. 1 illustrates creep strain versus time for a YAG refractory made in accordance with the present invention.

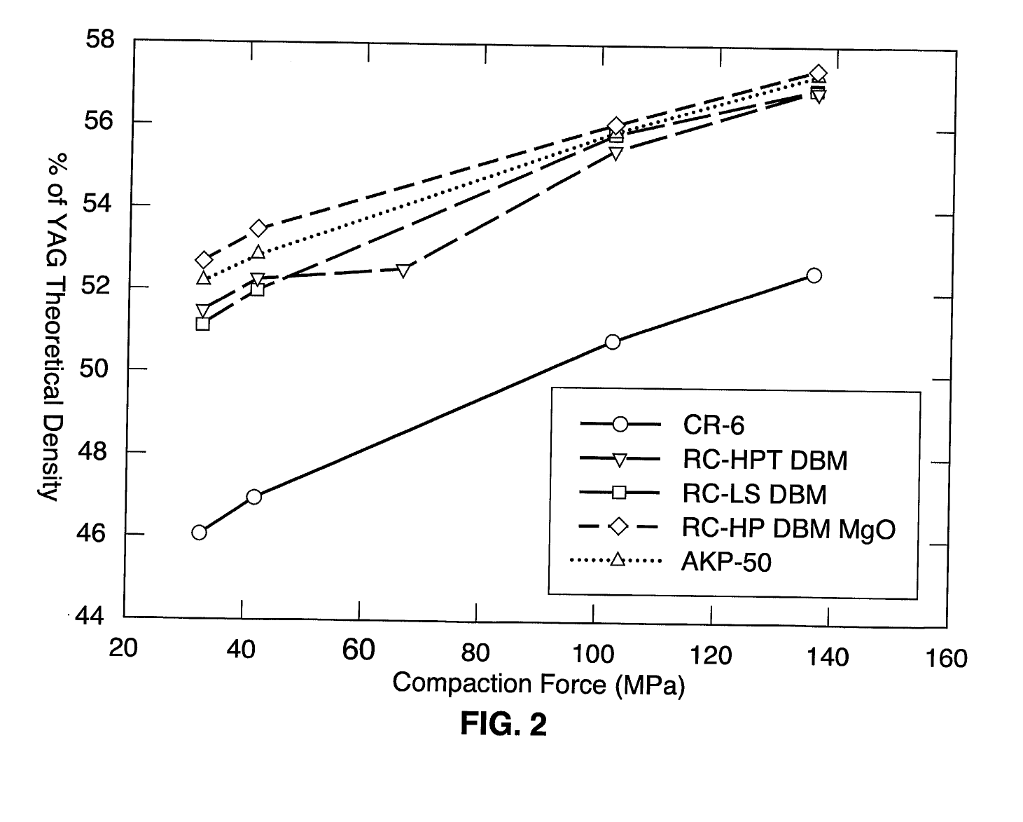

FIG. 2 illustrates the densification results for some rare-earth aluminum garnets of the present invention.

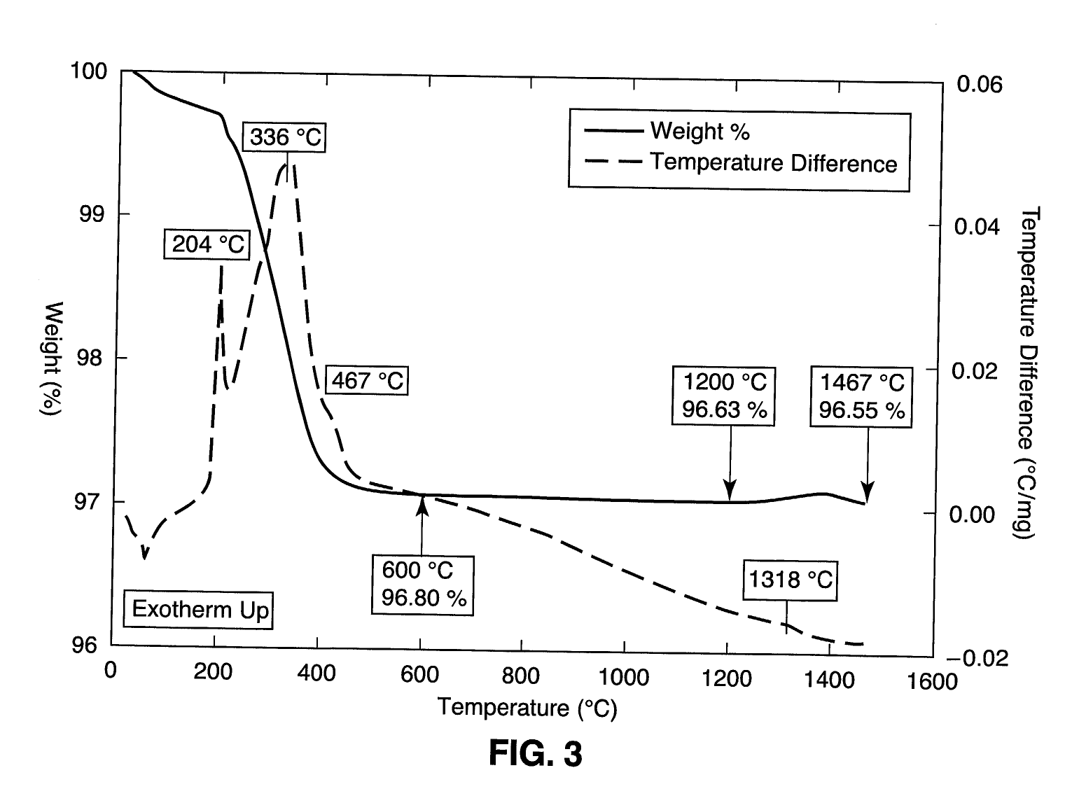

FIG. 3 illustrates the results of thermogravimetric analysis during processing of some of the compositions of the present invention.

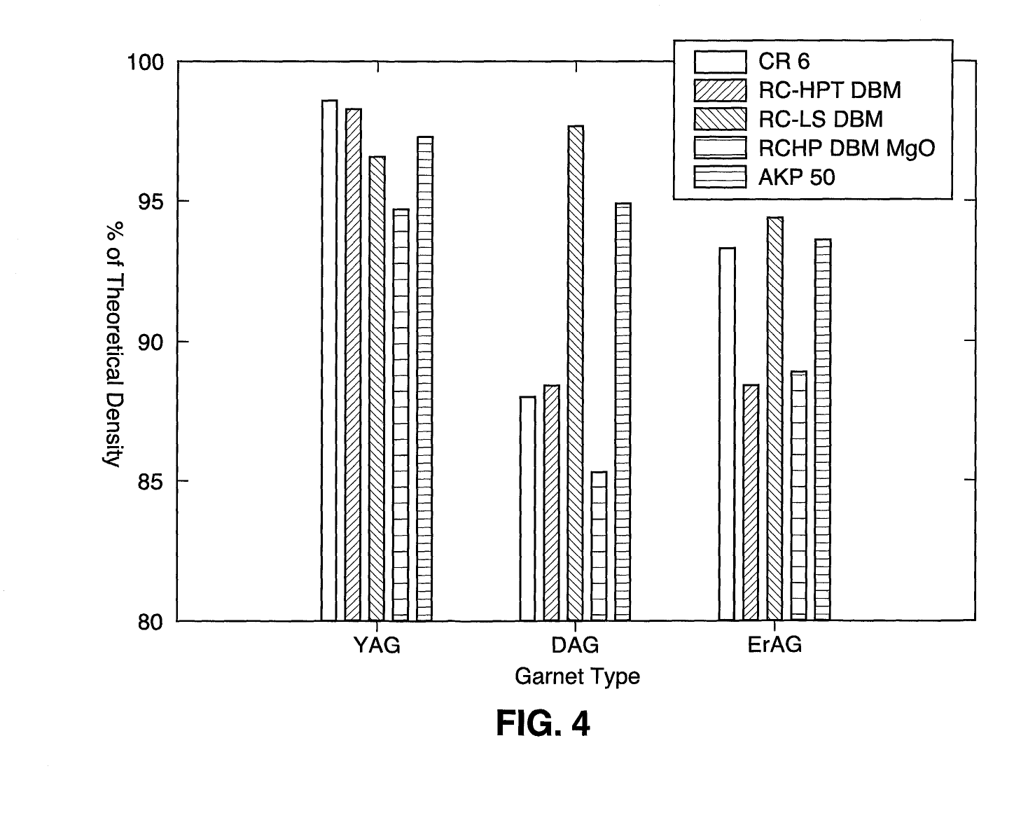

FIG. 4 presents the densities of several of the compositions of the present invention after firing at 1800° C.

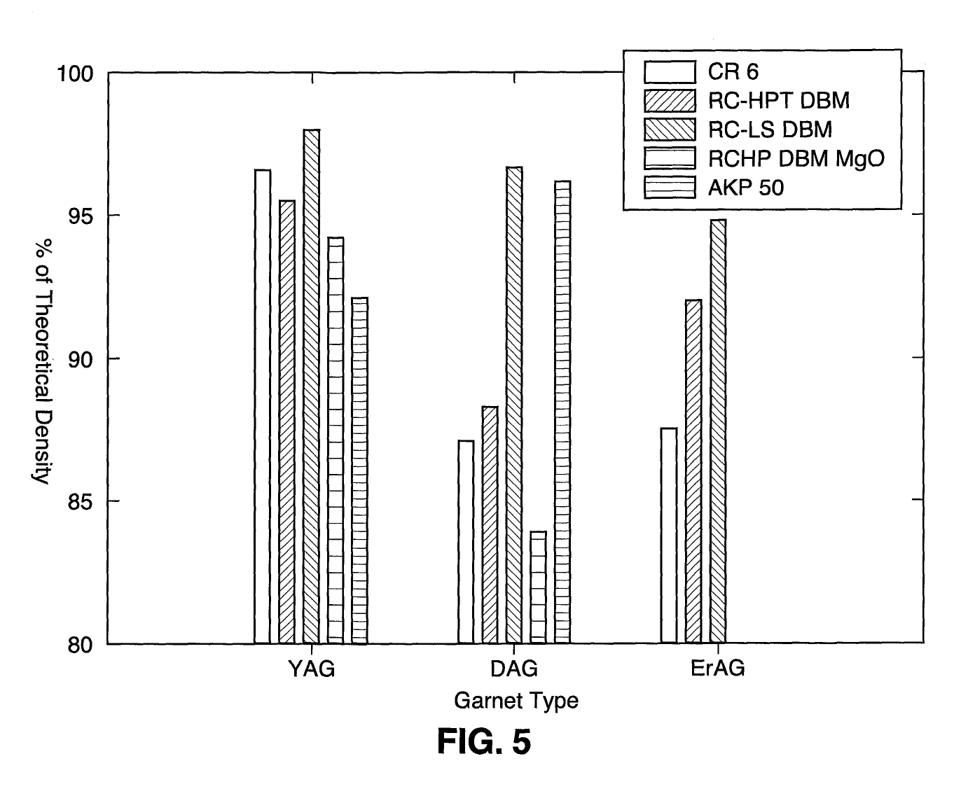

FIG. 5 presents the densities of several of the compositions of the present invention after firing at 1850° C.

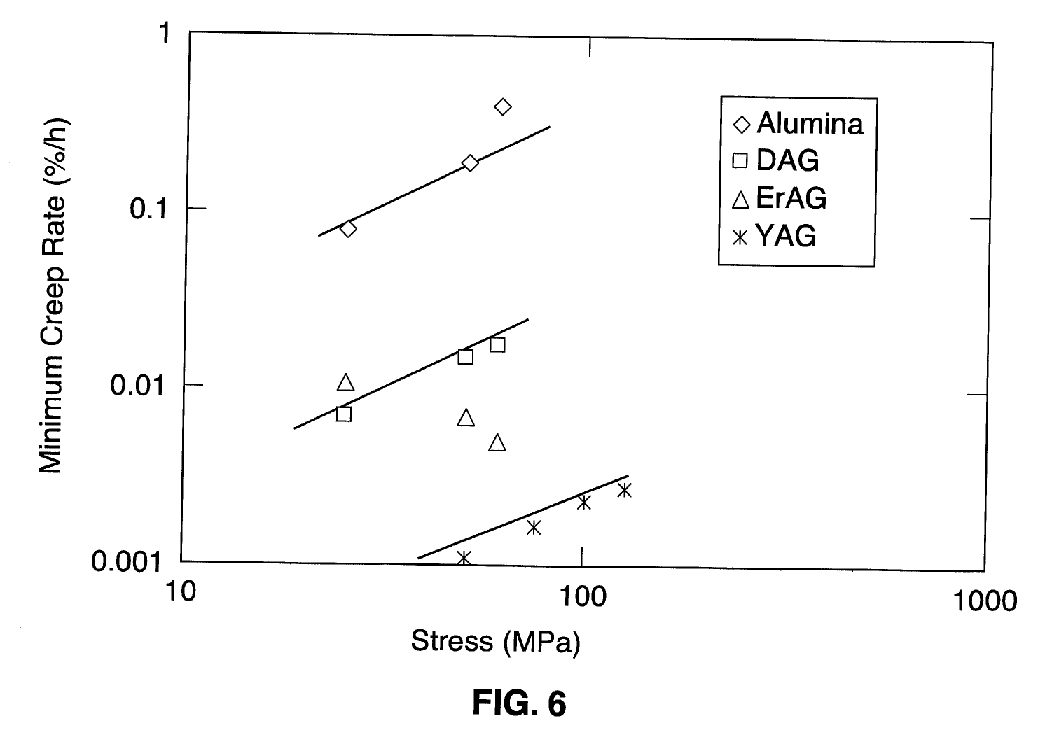

FIG. 6 summarizes creep test data for YAG, ErAG, and DyAG made in accordance with the present invention.

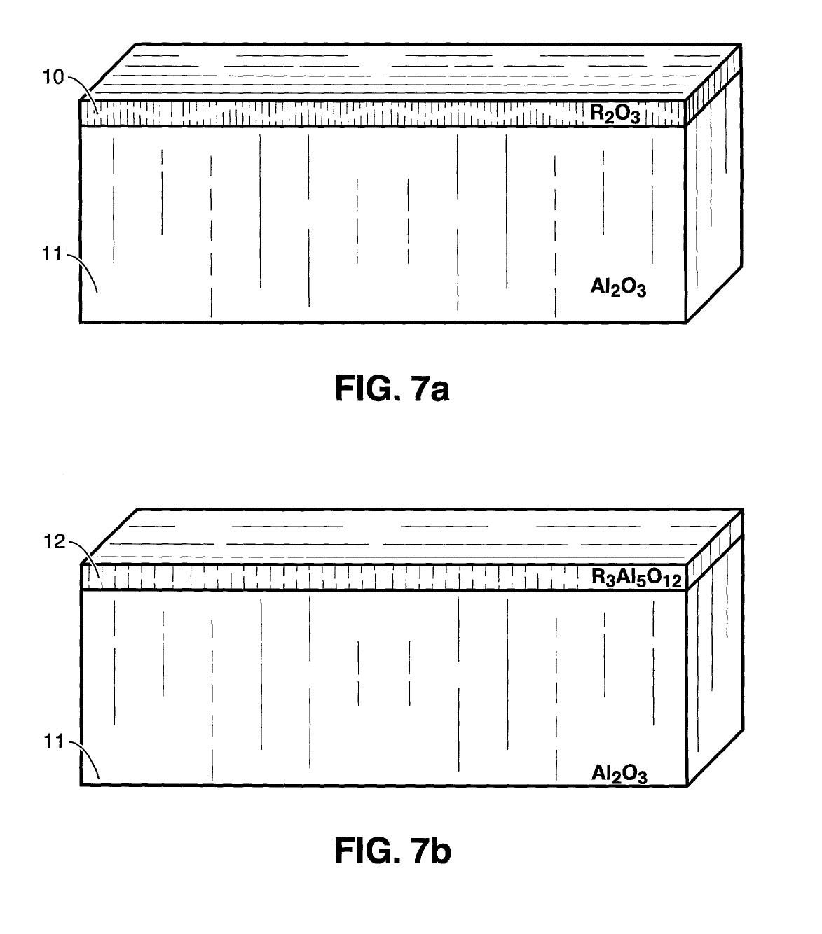

FIGS. 7a and 7b illustrate in an oblique view a layered refractory material made in accordance with another aspect of the present invention.

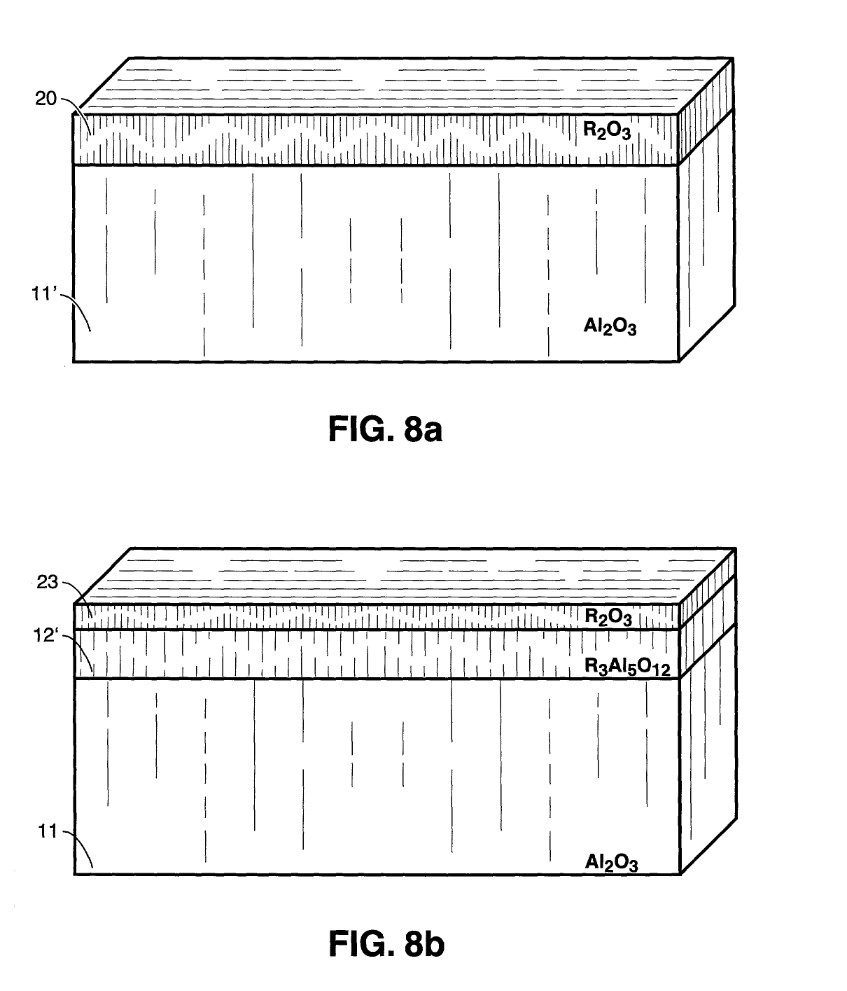

FIGS. 8a and 8b illustrate in an oblique view an alternate layered refractory material made in accordance with another aspect of the present invention.

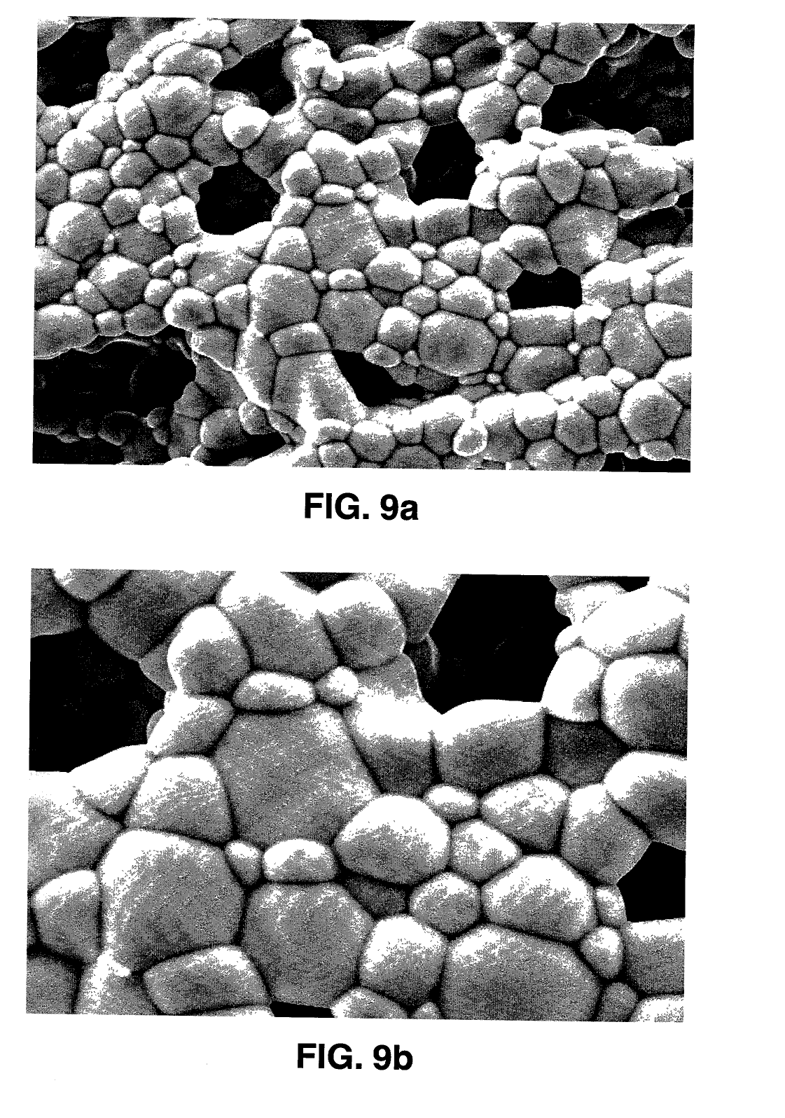

FIGS. 9a and 9b are photomicrographs that illustrate, at lower and higher magnification, respectively, the microstructure of a YAG:Ce (1%) coating made in accordance with one aspect of the present invention,

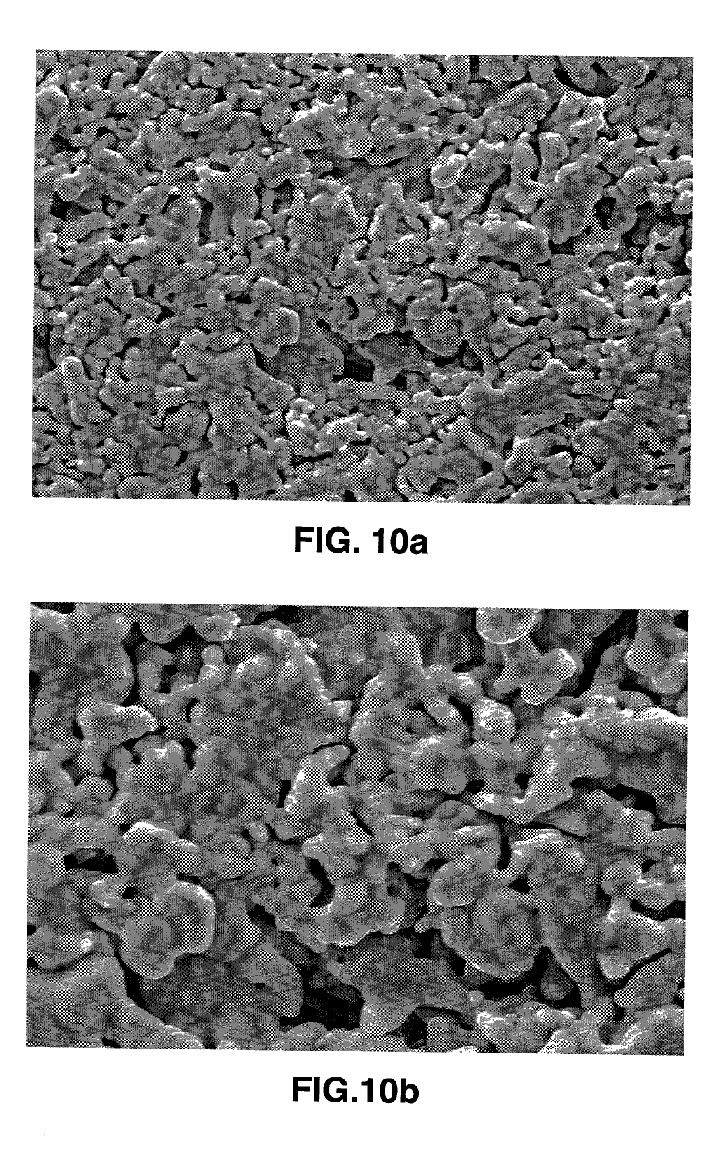

FIGS. 10a and 10b are photomicrographs that illustrate, at lower and higher magnification, respectively, the microstructure of a YAG:Sm (1%) coating made in accordance with one aspect of the present invention.

Based on the considerations enumerated above refractories have been made that are both creep resistant and have the ability to radiate selective spectral lines, usually in the IR spectrum (0.25 to 40 μm) controlled by the amount and type of dopants. It is known that not all rare-earth elements form the garnet phase (R₃Al₅O₁₂) with alumina. The most promising matrices would be Dy, Ho, Y, Er, Tm, Yb, and Lu aluminum garnets, since these elements have ionic radii, in the trivalent state, between 0.908 and 0.85 Å. Since the cost of rare-earth elements varies widely depending on their relative abundance, YAG, DyAG, and ErAG were examined as matrix phases.

In accordance with one aspect of the present invention, a creep-resistant and chemical-resistant ceramic refractory composition includes a mixed oxide of the general formula R₃Al₅O₁₂ where R is at least one of Dy, Ho, Y, Er, Tm, Yb, and Lu, the mixed oxide having a garnet structure and containing in solid solution at least one dopant of a transition metal element and/or a rare-earth element, which effects in the composition enhanced optical emission in at least one spectral range.

In accordance with another aspect of the present invention, a method of making a creep-resistant and chemical-resistant ceramic refractory composition includes the steps of:

Step a. mixing aluminum oxide and an oxide of at least one element R, where R is at least one of Dy, Ho, Y, Er, Tm, Yb, and Lu, in a molar ratio represented by the general formula R₃Al₅O₁₂;

Step b. adding at least one additional dopant element selected from transition metals and rare-earth elements, the dopant element selected to provide enhanced optical emission in at least one selected spectral range; and

Step c. heating the oxide mixture to a temperature of at least 1800° C. to form by liquid-phase sintering a densified mixed oxide having a garnet structure and containing the dopant element in solid solution.

In accordance with a further aspect of the present invention, a super-emissive refractory article includes a refractory alumina-containing substrate having thereon a coating comprising rare-earth aluminum garnet formed by in situ reaction of a selected rare-earth oxide with the alumina, the garnet farther including at least one optically active dopant of a transition metal element and/or a rare-earth element.

In accordance with yet another aspect of the present invention, a emissive refractory article includes a refractory alumina-containing substrate having thereon a coating comprising an emissive layer of a rare-earth oxide bonded to the substrate by an interlayer of rare-earth aluminum garnet formed by an in situ reaction between the rare-earth and the alumina.

In accordance with a further aspect of the present invention, a super-emissive ceramic refractory composition for use in reducing environments includes a garnet-structure mixed oxide of the general formula R₃Al₅O₁₂ where R is at least one of Dy, Ho, Y, Er, Tm, Yb, and Lu, and containing in solid solution at least one additional dopant of a transition metal and/or a rare-earth element, which is selected to provide an enhanced optical emission in at least one selected spectral range, the refractory composition being resistant to reduction and quenching of the optical emission by a reducing environment.

Skilled artisans will appreciate that while the large rare earth elements La, Nd, Sm, Eu, and Gd do not form the garnet phase with alumina, small amounts of these elements (probably less than about 10%) may be incorporated into the garnet structure. It will be further appreciated that the levels of optical dopants (used for example in laser materials) is typically less than this amount. In the examples described herein, dopant concentrations were typically in the 1-5% range.

The narrative description and explanation below explains how some samples of novel compositions were made in accordance with the present invention, and serves as an example of how small amounts of such compositions may be made. The exact amounts of materials used per se are not particularly critical to the invention.

Standard ceramic powder processing techniques were used to blend powder mixtures containing the oxides in the proper proportion to yield the garnet phase R₃Al₅O₁₂, where R is yttrium (YAG), dysprosium (DyAG) or erbium (ErAG). Table 1 gives the properties of the starting materials used in the blends. Each of the rare-earth oxides was a minimum of 99% total rare-earth oxide (TREO).

(Table 1 begins next page.)

TABLE 1
Materials Used in the Synthesis of Rare-Earth Garnet Samples

| | | | | Oxide/ |
|---|---|---|---|---|
| Oxide | Formula | Source | Lot # | TREO |
| Aluminum | Al₂O₃ | Baikowski CR-6 | — | |
| ″ | ″ | Malakoff RC-HPT | BM-2900 | |
| | | DBM | | |
| ″ | ″ | Malakoff RC-LS DBM | | |
| ″ | ″ | Malakoff RC-HPT | 2BL-2148 | |
| | | DBM with MgO | | |
| | | AKP-50 | — | |
| Cerium | CeO₂ | Pacific Industrial | 714802-0635 | 99.95% |
| | | Development | | |
| | | Corporation (PIDC) | | |
| Dysprosium | Dy₂O₃ | PIDC | 816301-1830 | 99.9% |
| Erbium | Er₂O₃ | PIDC | 917405-2230 | 99.9% |
| Gadolinium | Gd₂O₃ | PIDC | 831001-1440 | 99.99% |
| Neodymium | Nd₂O₃ | PIDC | 812401-1030 | 99.9% |
| Praseodymium | Pr₆O₁₁ | PIDC | 906301-0825 | 99.5% |
| Samarium | Sm₂O₃ | PIDC | 727404-123 | 99.9% |
| Terbium | Tb₄O₇ | PIDC | 818702-1640 | 99.99% |
| Yttrium | Y₂O₃ | Molycorp | | |

Typically a 100 g batch of the doped powder was prepared by weighing the oxides into a 250 ml bottle along with typical amounts of polyvinylpyrolidone (PVP) (average MW=10,000) as a dispersant/binder and carbowax 8000 as a lubricant/binder. The powders were blended for about 5 hr in 100 g of absolute ethyl alcohol at rolling mill with 300 g of alumina grinding media (6.45 mm OD×6.35 mm length). After mixing, the oxide slurry was decanted from the media, and the media was washed 4 times with approximately 50 ml portions of alcohol.

The washes were combined with the slurry and the alcohol was evaporated at 55° C. in an air-circulating drying oven. The large agglomerates in the dried powder were broken up by dry ball milling for about 2 hr with 10 mm yttria-doped zirconia balls. The resulting powder was sieved through a stainless steel No. 100 U.S.A. standard testing sieve. The oversize material was further reduced to pass through the No. 100 sieve by milling with a few zirconia media.

Table 2 gives the quantities used in the blends, and the calculated molar composition. The amount of media wear has been included in the total alumina added to the blends. The blends 78-1, 78-2 and 78-3 were used to make the creep test samples and were prepared in the same manner as the doped powders except that they were milled using 10 mm spherical yttria doped zirconia media (Performance Ceramics). Because of media wear, they contained a small amount of ZrO₂.

(Table 2 begins next page.)

TABLE 2
Material Quantities Used in Powder Blends

| | | | | Total Wt. in Mixture (g) | | | | | Molar Ratio of Elements | | | |
|---|---|---|---|---|---|---|---|---|---|---|---|---|
| | Al₂O₃ | Rare- | | | | | | carbowax | | | | |
| ID | Source | earth | Dopant | Re₂O₃ | Al₂O₃ | Dopant | PVP | 8000 | Re | Al | Dopant | O |
| 182-A | CR 6 | Y₂O₃ | none | 57.06 | 43.07 | | 1.25 | 1.25 | 3.00 | 5.01 | 0.00 | 12.02 |
| 182-B | RC-HPT | Y₂O₃ | none | 57.06 | 43.09 | | 1.25 | 1.25 | 3.00 | 5.02 | 0.00 | 12.03 |
| | DBM | | | | | | | | | | | |
| 182-C | RC-LS | Y₂O₃ | none | 57.06 | 43.26 | | 1.25 | 1.25 | 3.00 | 5.04 | 0.00 | 12.06 |
| | DBM | | | | | | | | | | | |
| 182-D | RCHP | Y₂O₃ | none | 57.06 | 43.10 | | 1.25 | 1.25 | 3.00 | 5.02 | 0.00 | 12.03 |
| | DBM MgO | | | | | | | | | | | |
| 182-E | AKP 50 | Y₂O₃ | none | 57.07 | 43.12 | | 1.25 | 1.25 | 3.00 | 5.02 | 0.00 | 12.03 |
| 194-A | CR 6 | Dy₂O₃ | none | 68.70 | 32.11 | | 1.24 | 1.25 | 3.00 | 5.13 | 0.00 | 12.19 |
| 194-B | RC-HPT | Dy₂O₃ | none | 68.70 | 32.13 | | 1.25 | 1.25 | 3.00 | 5.13 | 0.00 | 12.20 |
| | DBM | | | | | | | | | | | |
| 194-C | RC-LS | Dy₂O₃ | none | 68.71 | 32.49 | | 1.25 | 1.25 | 3.00 | 5.19 | 0.00 | 12.29 |
| | DBM | | | | | | | | | | | |
| 194-D | RCHP DBM | Dy₂O₃ | none | 68.70 | 32.09 | | 1.25 | 1.25 | 3.00 | 5.13 | 0.00 | 12.19 |
| | MgO | | | | | | | | | | | |
| 194-E | AKP 50 | Dy₂O₃ | none | 68.70 | 32.21 | | 1.26 | 1.25 | 3.00 | 5.15 | 0.00 | 12.22 |
| 222-A | CR 6 | Er₂O₃ | none | 69.24 | 30.67 | | 1.24 | 1.25 | 3.00 | 4.98 | 0.00 | 11.98 |
| 222-B | RC-HPT | Er₂O₃ | none | 69.24 | 31.34 | | 1.25 | 1.25 | 3.00 | 5.09 | 0.00 | 12.14 |
| | DBM | | | | | | | | | | | |
| 222-C | RC-LS | Er₂O₃ | none | 69.24 | 30.63 | | 1.25 | 1.25 | 3.00 | 4.98 | 0.00 | 11.97 |
| | DBM | | | | | | | | | | | |
| 222-D | RCHP DBM | Er₂O₃ | none | 69.24 | 30.71 | | 1.25 | 1.25 | 3.00 | 4.99 | 0.00 | 11.99 |
| | MgO | | | | | | | | | | | |
| 222-E | AKP 50 | Er₂O₃ | none | 69.24 | 30.61 | | 1.25 | 1.25 | 3.00 | 4.98 | 0.00 | 11.96 |
| 276-A | RC-HPT | Y₂O₃ | CeO₂ | 56.34 | 42.90 | 0.88 | 1.24 | 1.25 | 2.97 | 5.01 | 0.03 | 12.03 |
| | DBM | | | | | | | | | | | |
| 276-B | RC-HPT | Y₂O₃ | Gd₂O₃ | 56.36 | 42.87 | 0.91 | 1.25 | 1.25 | 2.97 | 5.00 | 0.03 | 12.00 |
| | DBM | | | | | | | | | | | |
| 276-C | RC-HPT | Y₂O₃ | Pr₆O₁₁ | 56.30 | 42.91 | 0.86 | 1.26 | 1.25 | 2.97 | 5.01 | 0.03 | 12.03 |
| | DBM | | | | | | | | | | | |
| 276-D | RC-HPT | Y₂O₃ | Sm₂O₃ | 56.32 | 42.90 | 0.88 | 1.25 | 1.25 | 2.97 | 5.01 | 0.03 | 12.01 |
| | DBM | | | | | | | | | | | |
| 21-A | RC-HPT | Y₂O₃ | Er₂O₃ | 56.25 | 42.79 | 0.96 | 1.24 | 1.25 | 2.97 | 5.00 | 0.03 | 12.00 |
| | DBM | | | | | | | | | | | |
| 21-B | RC-HPT | Y₂O₃ | Tb₄O₇ | 56.29 | 42.81 | 0.94 | 1.25 | 1.25 | 2.97 | 5.00 | 0.03 | 12.01 |
| | DBM | | | | | | | | | | | |
| 21-C | RC-HPT | Y₂O₃ | Dy₂O₃ | 56.28 | 42.80 | 0.94 | 1.26 | 1.25 | 2.97 | 5.00 | 0.03 | 11.99 |
| | DBM | | | | | | | | | | | |
| 21-D | RC-HPT | Y₂O₃ | Dy₂O₃ | 53.22 | 42.17 | 4.63 | 1.25 | 1.25 | 2.85 | 5.00 | 0.15 | 11.93 |
| | DBM | | | | | | | | | | | |
| 34-A | RC-HPT | Y₂O₃ | Er₂O₃ | 54.00 | 42.43 | 0.95 | 1.25 | 1.25 | 2.88 | 5.01 | 0.03 | 12.02 |
| | DBM | | | | | | | | | | | |
| | | | Tb₄O₇ | | | 0.93 | | | | | 0.03 | |
| | | | Dy₂O₃ | | | 0.93 | | | | | 0.03 | |
| | | | Sm₂O₃ | | | 0.87 | | | | | 0.03 | |
| 34-B | RC-HPT | Dy₂O₃ | CeO₂ | 68.07 | 31.36 | 0.63 | 1.25 | 1.25 | 2.97 | 5.01 | 0.03 | 12.02 |
| | DBM | | | | | | | | | | | |
| 34-C | RC-HPT | Dy₂O₃ | Gd₂O₃ | 68.03 | 31.35 | 0.67 | 1.26 | 1.25 | 2.97 | 5.01 | 0.03 | 12.01 |
| | DBM | | | | | | | | | | | |
| 34-D | RC-HPT | Dy₂O₃ | Pr₆O₁₁ | 68.07 | 31.36 | 0.63 | 1.25 | 1.25 | 2.97 | 5.01 | 0.03 | 12.02 |
| | DBM | | | | | | | | | | | |
| 43-A | RC-HPT | Dy₂O₃ | Sm₂O₃ | 68.04 | 31.32 | 0.64 | 1.25 | 1.25 | 2.97 | 5.00 | 0.03 | 12.00 |
| | DBM | | | | | | | | | | | |
| 43-B | RC-HPT | Dy₂O₃ | Er₂O₃ | 68.00 | 31.26 | 0.70 | 1.24 | 1.25 | 2.97 | 4.99 | 0.03 | 11.99 |
| | DBM | | | | | | | | | | | |
| 43-C | RC-HPT | Dy₂O₃ | Tb₄O₇ | 68.02 | 31.27 | 0.69 | 1.25 | 1.25 | 2.97 | 4.99 | 0.03 | 12.00 |
| | DBM | | | | | | | | | | | |
| 43-D | RC-HPT | Dy₂O₃ | Nd₂O₃ | 68.01 | 31.26 | 0.62 | 1.26 | 1.25 | 2.97 | 4.99 | 0.03 | 11.99 |
| | DBM | | | | | | | | | | | |
| 51-A | RC-HPT | Dy₂O₃ | Nd₂O₃ | 65.27 | 31.28 | 3.10 | 1.24 | 1.25 | 2.85 | 5.00 | 0.15 | 12.00 |
| | DBM | | | | | | | | | | | |
| 51-B | RC-HPT | Dy₂O₃ | Er₂O₃ | 66.66 | 31.28 | 0.71 | 1.25 | 1.25 | 2.91 | 4.99 | 0.03 | 12.05 |
| | DBM | | | | | | | | | | | |
| | | | Sm₂O₃ | | | 0.64 | | | | | 0.03 | |
| | | | Tb₄O₇ | | | 0.69 | | | | | 0.03 | |
| 51-C | RC-HPT | Er₂O₃ | CeO₂ | 68.62 | 30.80 | 0.62 | 1.25 | 1.25 | 2.97 | 5.00 | 0.03 | 12.02 |
| | DBM | | | | | | | | | | | |
| 51-D | RC-HPT | Er₂O₃ | Gd₂O₃ | 68.57 | 30.79 | 0.66 | 1.26 | 1.25 | 2.97 | 5.00 | 0.03 | 12.00 |
| | DBM | | | | | | | | | | | |
| 92-A | RC-HPT | Er₂O₃ | Pr₆O₁₁ | 68.61 | 30.79 | 0.62 | 1.25 | 1.25 | 2.97 | 5.00 | 0.03 | 12.01 |
| | DBM | | | | | | | | | | | |
| 92-B | RC-HPT | Er₂O₃ | Sm₂O₃ | 68.59 | 30.78 | 0.63 | 1.25 | 1.25 | 2.97 | 5.00 | 0.03 | 12.00 |
| | DBM | | | | | | | | | | | |
| 92-C | RC-HPT | Er₂O₃ | Dy₂O₃ | 68.55 | 30.76 | 0.68 | 1.25 | 1.25 | 2.97 | 5.00 | 0.03 | 12.00 |
| | DBM | | | | | | | | | | | |
| 92-D | RC-HPT | r₂O₃ | Tb₄O₇ | 68.57 | 30.77 | 0.68 | 1.25 | 1.25 | 2.97 | 5.00 | 0.03 | 12.01 |
| | DBM | | | | | | | | | | | |
| 139-A | RC-HPT | Er₂O₃ | Dy₂O₃ | 65.78 | 30.76 | 3.38 | 1.24 | 1.25 | 2.97 | 5.21 | 0.16 | 12.50 |
| | DBM | | | | | | | | | | | |
| 139-B | RC-HPT | Er₂O₃ | Ce₂O₃ | 68.83 | 30.89 | 0.28 | 1.26 | 1.25 | 2.97 | 5.00 | 0.03 | 12.00 |
| | DBM | | | | | | | | | | | |
| 139-C | RC-HPT | Er₂O₃ | Dy₂O₃ | 67.24 | 30.79 | 0.68 | 1.26 | 1.25 | 2.91 | 5.00 | 0.03 | 11.91 |
| | DBM | | | | | | | | | | | |
| | | | Sm₂O₃ | | | 0.64 | | | | | 0.03 | |
| | | | Tb₄O₇ | | | 0.69 | | | | | 0.03 | |
| 78-1 | RC-HPT | Y₂O₃ | ZrO₂ | 142.65 | 107.35 | 0.35 | 3.13 | 3.13 | 3.00 | 5.00 | 0.01 | 12.01 |
| | DBM | | | | | | | | | | | |
| 78-2 | RC-HPT | Dy₂O₃ | ZrO₂ | 171.75 | 78.25 | 0.50 | 3.13 | 3.13 | 3.00 | 5.00 | 0.03 | 12.03 |
| | DBM | | | | | | | | | | | |
| 78-3 | RC-HPT | Er₂O₃ | ZrO₂ | 173.11 | 76.90 | 0.39 | 3.13 | 3.12 | 3.00 | 5.00 | 0.02 | 12.02 |
| | DBM | | | | | | | | | | | |

Cylindrical rods of sample materials 0.5 in. OD were prepared by uniaxial cold pressing the powders in a steel die using a standard laboratory press. A thin film of stearic acid was used as a release agent. As expected, the green density increased with an increase in the force used to compact the samples. The densification data for YAG is shown in FIG. 2. Ten to fifteen grams of powder were pressed at 35 MPa. and the cold pressed rods were further compacted in an isostatic press at 345 MPa. Isostatic pressing was done with the samples sealed inside an evacuated latex rubber bag to prevent contamination from the compression fluid. The final green densities were the highest for the YAG compositions, and were the lowest for the ErAG composition. The densities were lower for the powders blended with CR-6 alumina, and were the highest for the blends using RC-LS DBM alumina.

The organic binders were removed from the green samples by heating in air. Thermogravimetric analysis and differential thermal analysis of pressed pellets of the undoped blends showed that the samples began losing weight rapidly around 200° C. As shown in FIG. 3, associated with this weight loss was an exotherm that reached a maximum around 335° C. Furthermore, by the time the sample temperature had reached 600° C., greater than 90% of the weight loss had occurred. Based on this decomposition behavior, the binder was removed by heating to 300° C. at 1° C./min; holding at 300° C. for 1 hr.; heating at 1° C./min to 600° C. and holding for 1 hr before cooling to room temperature.

Several different grades of alumina are commercially available. Impurities, as well as the particle size of the starting powders, can affect (1) the rate of densification, (2) the sintered density and (3) the high temperature creep rate of the final ceramic. Initially YAG, DyAG and ErAG were blended using the commercial alumina powders shown in Table 1. The blends were wet milled and the average particle sizes were determined using a laser particle size distribution analyzer.

The effects that the alumina grade, the anneal time and the anneal temperature have on the density of the product was investigated by heating isostatically pressed disks in a tungsten vacuum furnace under a vacuum of ˜2×10⁻⁵ torr. The densities (expressed as % theoretical density (TD)) of the samples sintered for 5 hr at 1800 and 1850° C. are shown in FIGS. 4 and 5, respectively. All samples tested sintered to at least 85% TD, and some samples sintered to about 98% TD. At both temperatures, the YAG sintered to the highest density and the DAG had the lowest density. For most of the compositions, the samples heated at 1800° C. had a higher density than the samples heated at 1850° C. The type of alumina used in the blend had a pronounced effect on the final densities for the DAG and ErAG composition. Powder blended with RC-LS DBM and with AKP-50 grades gave the highest densities. The RC-HP DBM with added MgO (519 ppm) usually resulted in the lowest density. The grade of alumina had little effect on the YAG densities. The RC-LS DBM alumina had the largest amount of impurities of the aluminas used in the blends. The major impurities were Fe₂O₃ (146 ppm), Na₂O (548 ppm), SiO₂ (404 ppm), CaO (414 ppm), MgO (9 ppm) and ZnO (87 ppm). Because of the concern that impurities may increase the creep rate due to glass formation during sintering, the doped specimens and the creep specimens were formulated using the higher purity RC-EPT DBM alumina. This alumina contains Fe₂O₃ (53 ppm), Na₂O (79 ppm), SiO₂ (37 ppm), CaO (79 ppm) and MgO (19 ppm).

### EXAMPLE I

Creep testing was carried out as described by A. A. Wereszczak, M. K. Ferber, T. P. Kirkland, A. S. Barnes, E. L. Frome, and M. N. Menon, “Asymmetric Tensile and Compressive Creep Deformation of Hot-isostatically-pressed Y₂O₃-Doped-Si₃N₄,” J. Eur. Cer. Soc. 19, 227-237 (1999). The preliminary data generated at 1200° C. indicated that the creep deformation in the rare-earth garnets was negligible. Therefore, the results described below focus on the 1300° C. data. A typical creep strain versus time curve generated for the YAG specimen is shown in FIG. 1. To compare the creep response of the various materials, the minimum creep rate was calculated for each stress segment. FIG. 6 summarizes these data. The creep performance of all 3 rare-earth aluminum garnets exhibited was significantly better than that of the AD995 alumina. Furthermore, the creep curve for YAG material was approximately 100 times better than the alumina curve. The slopes of the creep rate versus stress curves were comparable for all materials (approximately 1) with the exception of the ErAG which exhibited a negative stress dependency. For this material, it is likely that the other time dependent processes affecting specimen length (phase transformations, sintering, etc.) occurred in addition to the creep.

The creep data presented in FIG. 6 are particularly striking in view of the fact that that none of the samples were fully dense. The skilled artisan will appreciate the engineering implications thereof. Material that is less than fully dense will have better insulating properties, which are contemplated to be important for many refractory applications. Moreover, if these materials were made into a fully dense condition (by longer sintering or more reactive starting powders, for example) they would be even more creep resistant, which is also contemplated to be important for many refractory applications. Thus, such properties are easily controllable and preselectable.

### EXAMPLE II

To demonstrate that rare-earth fluorescence was possible from the samples, each sample was illuminated with UV light (λ−0.38 μm) and checked for visible fluorescence. About half of the doped samples exhibited visible fluorescence. For example, bright yellow fluorescence was observed from the YAG:Ce (1%) sample. Regions of non-fluorescence were present in the samples that did fluoresce, indicating that the sample was not completely single phase and/or the dopant species was not uniformly distributed. Visible fluorescence of doped YAGs is summarized qualitatively in Table 3. All of the doped ErAG appeared to have a fluorescent dull violet color and all of the doped DyAG appeared dull brownish green.

(Table 3 begins next page.)

TABLE 3
Visible fluorescence of doped YAGs

| Dopant | Color | Intensity |
|---|---|---|
| 1% Ce | yellow | bright |
| 1% Gd | brown | dull |
| 1% Pr | brown | dull |
| 1% Sm | orange | bright |
| 1% Er | yellow-green | medium |
| 1% Tb | yellow-lemon | dull |
| 1% Dy | peach | medium |
| 5% Dy | peach | not noted |

### EXAMPLE III

Selected samples were also illuminated with a UV lamp while observing them in an IR camera and it was seen that IR emissions increased while under illumination, thereby further demonstrating that the materials were super-emissive in the IR spectral region.

In view of the foregoing results, various experiments were conducted to develop suitable processing schemes for both monolithic materials and coatings based on the claimed compositions.

### EXAMPLE IV

Consideration of the Al₂O₃—Y₂O₃ phase diagram indicated that eutectics existed on either side of the desired Y₃Al₅O₁₂ compound. When an intimate mixture of the pure oxides was heated to a temperature just above this eutectic point, liquid phases were formed, which rapidly infiltrated throughout the structure, giving fairly rapid densification. Once the entire sample had been converted to the garnet structure, sintering ceased and the material was highly refractory and creep resistant, even if less than fully dense.

The transient liquid phase appeared to be a general property of the compositions of the present invention and has further implications for making coatings by in situ reactions with an alumina-containing substrate, as will be described in the following examples.

### EXAMPLE V

Based upon the foregoing considerations, a layered refractory material is made wherein specific rare-earth elements and dopants are applied to the radiant surface of a lower-cost alumina refractory substrate. As shown in FIG. 7a, a relatively thin R₂O₃ layer 10 is applied to the surface of the alumina substrate 11. (R=at least one rare earth element, for example, Y) During firing these materials react to form a layer 12 that is substantially R₃Al₅O₁₂. Any desired dopants are incorporated into the coating at the same time by mixing their constituent oxides with the R₂O₃. Some alumina is optionally added to the coating 10 to further improve the reactive bonding process.

### EXAMPLE VI

A further modification of the compositions of the present invention is shown in FIG. 8. In this example, a thicker R₂O₃ layer 20 is applied to an alumina refractory 11′. After the in situ reaction is complete, some unreacted rare-earth oxide 23 exists at the surface, bonded to the substrate 11′ by an intermediate Y₃Al₅O₁₂ layer 12′.

### EXAMPLE VII

Paints comprising about 30 vol. % doped YAG precursor powder, 47 vol. % water and 23 vol. % glycol ether were formulated according to Table 4 as follows: Into a 30 ml bottle was placed a weighed amount of the mixed oxide powder and about 6 g of 1 mm spherical ZrO₂ grinding media. Deionized water (2 ml) and propylene glycol methyl ether (PGME) (1 ml) were added with a syringe. The mixture was sonicated in an ultrasonic bath for 30 minutes to produce a suspension. Because the suspension settled with time, the paints were mixed by shaking prior to each use.

The paints were brushed onto an Alumina/Zirconia board, dried at room temperature and then heated to 1600° C. at 10° C./min in an air circulating furnace with a 1 hr dwell time at 1600° C. After firing, these coatings displayed characteristic fluorescence when illuminated by UV light. The coatings were thin, dense, scratch resistant, and adhered strongly to the substrate.

The fired coatings were examined by scanning electron microscopy (SEM) at magnifications ranging from 1000 to 10,000×. FIGS. 9a and 9b illustrate, at lower and higher magnification, respectively, the structure of a YAG:Ce (1%) coating. Several surprising features can be seen in the photomicrograph. First, the coating is very highly sintered, as shown by the rounded polygonal grain structure. More surprisingly, there are well-distributed openings in the film, thereby forming a reticulated structure. This reticulated structure further enhances the emissivity, so the end result is a mantle-like emissive structure, but one that is simultaneously strong and securely attached to the underlying substrate. This combination of properties was unexpected for these compositions.

FIGS. 10a and 10b illustrate the structure of a YAG:Sm (1%) coating at the same respective magnifications as the previous figure. Several surprising features become evident. First, the overall structure is well sintered, yet the individual grains in the coating are finer by about a factor of five, even though the only difference between the two samples is the particular rare earth dopant used. Second, this coating unexpectedly also contains distributed porosity that contributes to improved emissivity even though the coating is strong and adherent to the substrate.

The structure of the YAG:Pr coating was found to have a structure similar to that of the YAG:Ce coating. The structure of the YAG:Tb coating was found to have a structure similar to that of the YAG:Sm coating.

TABLE 4
Composition of doped YAG paints

| | | 1 mm ZrO₂ | | | |
|---|---|---|---|---|---|
| YAG | Dopant | media (g) | Powder (g) | Water (g) | PGME (g) |
| 12-A | 1% Ce | 6.085 | 5.605 | 1.992 | 0.915 |
| 12-B | 1% Tb | 6.148 | 5.461 | 1.988 | 0.927 |
| 12-C | 1% Sm | 6.217 | 5.662 | 2.001 | 0.922 |
| 12-D | 1% Pr | 6.393 | 5.525 | 2.013 | 0.932 |

It will be appreciated that it might be desirable to introduce more than one dopant element into a given system, thereby taking advantage of several sets of emission lines simultaneously. At the same time, placing several dopants into one host crystal can introduce unexpected energy states that can have the effect of quenching out previously active emission lines. To avoid this problem, the coating technique described in the previous example can be further modified as follows.

### EXAMPLE VIII

An undoped layer of R₂O₃ is first disposed upon the substrate. Then, several dopants are applied to different areas of the surface (analogous to pixels on a color television screen) so that each “pixel” is free to radiate its characteristic spectral lines without unwanted absorption effects from the other dopants. After firing, the surface will then have the property of being able to radiate many different spectral lines into the surrounding gas phase.

It has thus been shown that extremely high creep resistance can be achieved in various rare-earth aluminum garnets while also allowing the selection of a large number of optically active dopants. Furthermore, by forming the garnet compound during sintering (by starting with the constituents as pure oxides) one can easily densify the material and assure that the dopants become effectively incorporated into the host garnet phase. By contrast, YAG powder, once synthesized, is very poorly sinterable. Applicants have discovered, surprisingly, that while YAG is perhaps the best matrix from the standpoint of creep resistance alone, other rare-earth aluminum garnets have creep resistance that is still 10 times better than that of alumina. It is contemplated that the superior creep resistance of YAG can now be reliably extended to other rare-earth aluminum garnets and that these same garnets can serve as extremely stable hosts to many dopants, thereby creating more opportunities for selective emission. These alternative matrices provide more possibilities for hosting dopants with spectral emissions in selected regions for selected applications.

While it is contemplated that monolithic refractories are most useful where high-temperature strength is desirable, the compositions of the present invention are also suitable for wash coats in some applications. It is particularly important to note that the cost of the rare-earth elements can be minimized by making a “generic” YAG material and merely doping the outer surface with a selected dopant (many of which are much more costly than Y). It is also possible to apply a Y₂O₃ coating (containing small amounts of other rare-earth dopants) to an alumina refractory and fire it to form the garnet phase in situ over a base layer of less costly alumina as described in the foregoing examples.

Skilled artisans will appreciate that several factors must be considered in selecting the exact coating composition and thickness for a particular application. First, for cases where high rates of wear or erosion might be expected and the cost of downtime is high, a thicker coating (several millimeters) might be desired. Conversely, for the case of very costly dopants and low wear rates, a thinner coating (perhaps 50 microns) might be more desirable. It will also be appreciated that the optical emission from the coating will generally originate near the surface, so an excessively thick coating would not make optimal use of the active species.

It will be appreciated that the compositions of the present invention allow the designer to exploit the favorable creep properties of rare-earth aluminum garnets and the super-emissive properties of rare-earth oxides in general. Moreover, the outstanding resistance of YAG to reducing environments further enhances its utility as a stable host for optically active dopants.

It will be understood that the compositions of the present invention can also be formed by other techniques similar in principle to the methods described in the foregoing examples. For example, all of the aforedescribed oxides may be synthesized as very fine, highly reactive powders by sol-gel, alkoxide, coprecipitation, or similar processes. The materials can also be made in low-density form by fiber extrusion or by well-known relic methods if an extremely creep-resistant emissive mantle is needed for demanding applications. Thus, using the teachings contained herein, the skilled artisan can achieve the optimal combination of properties for a given application without undue experimentation.

While there has been shown and described what are at present considered the preferred embodiments of the invention, it will be obvious to those skilled in the art that various changes and modifications can be prepared therein without departing from the scope of the inventions defined by the appended claims.

What is claimed is:

1. A creep-resistant and chemical-resistant ceramic refractory composition comprising a mixed oxide of the general formula R₃Al₅O₁₂ where R is at least one element selected from the group consisting of Dy, Ho, Y, Er, Tm, Yb, and Lu, said mixed oxide having a garnet structure, said mixed oxide further comprising in solid solution at least one dopant selected from the group consisting of transition metal elements and rare-earth elements, said dopant effecting in said composition enhanced optical emission in at least one spectral range.

2. A composition in accordance with claim 1 having a density of at least 85% of theoretical density.

3. A composition in accordance with claim 1 wherein said dopant is present in a concentration in a range of about 1 to about 10 mol %.

4. A composition in accordance with claim 1 wherein said selected spectral range comprises at least one optical wavelength in a range of about 0.25 to about 40 μm.

5. A method of making a creep-resistant and chemical-resistant ceramic refractory composition comprising the steps of:
a. mixing aluminum oxide and an oxide of at least one element R selected from the group consisting of Dy, Ho, Y, Er, Tm, Yb, and Lu in a molar ratio represented by the general formula R₃Al₅O₁₂;
b. adding at least one additional dopant element selected from the group consisting of transition metals and rare-earth elements, said dopant element selected to provide enhanced optical emission in at least one selected spectral range; and
c. heating said oxide mixture to a temperature of at least 1800° C. to form by liquid-phase sintering a densified mixed oxide having a garnet structure, said mixed oxide further comprising said dopant element in solid solution.

6. A method in accordance with claim 5 wherein said heating step is carried out in air and wherein said refractory composition has a final density of at least 85% of theoretical density.

7. A method in accordance with claim 5 wherein said dopant element is present in a concentration in a range of about 1 to about 10 mol %.

8. A method in accordance with claim 5 wherein said selected spectral range comprises at least one optical wavelength in a range of about 0.25 μm to about 40 μm.

9. A super-emissive refractory article comprising a refractory alumina-containing substrate having thereon a coating comprising rare-earth aluminum garnet formed by in situ reaction of a selected rare-earth oxide with said alumina, said garnet further comprising at least one optically active dopant selected from the group consisting of transition metal elements and rare-earth elements.

10. A super-emissive refractory article in accordance with claim 9 wherein said base composition comprises at least 85% Al₂O₃.

11. A super-emissive refractory article in accordance with claim 9 wherein said coating has a final thickness of less than about 3 mm.

12. A super-emissive refractory article in accordance with claim 9 wherein said dopant is present in a concentration in a range of about 1 to about 10 mol %.

13. A super-emissive refractory article in accordance with claim 9 wherein said selected spectral range comprises at least one optical wavelength in a range of about 0.25 μm to about 40 μm.

14. An emissive refractory article comprising a refractory alumina-containing substrate having thereon a coating comprising an emissive layer of a rare-earth oxide bonded to said substrate by an interlayer of rare-earth aluminum garnet formed by an in situ reaction between said rare-earth and said alumina.

15. An emissive refractory article in accordance with claim 14 wherein said substrate comprises at least 85% Al₂O₃.

16. An emissive refractory article in accordance with claim 14 wherein said emissive layer has a final thickness of less than about 3 mm.

17. An emissive refractory article in accordance with claim 14 wherein said dopant element is present in a concentration in a range of about 1 to about 10 mol %.

18. An emissive refractory article in accordance with claim 14 wherein said selected spectral range comprises at least one optical wavelength in a range of about 0.25 μm to about 40 μm.

19. A super-emissive ceramic refractory composition for use in reducing environments comprising a garnet-structure mixed oxide of the general formula R₃Al₅O₁₂ where R is an element selected from the group consisting of Dy, Ho, Y, Er, Tm, Yb, and Lu, said mixed oxide further comprising in solid solution at least one additional dopant element selected from the group consisting of transition metals and rare-earth elements, said dopant element selected to provide an enhanced optical emission in at least one selected spectral range, said refractory composition being resistant to reduction and quenching of said optical emission by a reducing environment.

20. A super-emissive refractory composition in accordance with claim 19 having a density of at least 85% of theoretical density.

21. A super-emissive refractory composition in accordance with claim 19 wherein said dopant element is present in a concentration in a range of about 1 to about 10 mol %.

22. A super-emissive refractory composition in accordance with claim 19 wherein said selected spectral range comprises optical wavelengths in a range of about 0.25 μm to about 40 μm.
